(19) United States
(12) Patent Application Publication
(10) Pub. No.: US 2003/0081406 A1
(43) Pub. Date: May 1, 2003

(54) Solar lamp in combination with a fountain

(76) Inventor: Chung-Kuei Lin, Hsinchuang City (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/002,481

(22) Filed: Nov. 1, 2001

(51) Int. Cl. F21V 33/00; F21L 13/00

(52) U.S. Cl. 362/96; 362/101; 362/183; 362/253

(57) ABSTRACT

A solar lamp in combination with a fountain has a base which is hollow and has a top opening. A disk covers the top opening and has multiple communicating holes defined through the disk. A connector which is hollow is mounted on top of the disk and communicates with the pump via a hose. A cylinder which is hollow is securely connected and communicates with the connector via a tube. The cylinder has an outlet defined in a top face of the cylinder and multiple protrusions are formed in the top face to securely connect a solar lamp to the cylinder. Therefore, the solar lamp in combination with the fountain is able to create waterfalls for ornamental purpose and the solar lamp is able to provide illumination under dimly-lit conditions.

### BACKGROUND OF THE INVENTIONS

1. Field of the Invention

The present invention relates to a solar lamp in combination with a fountain, wherein a solar lamp and a fountain are combined together to provide an ornamental effect as well as illumination for open spaces.

2. Description of Related Art

Solar lamps are known articles which have a battery that is charged during daylight hours by solar radiation and provide illumination at night in gardens and open spaces. The solar lamps have numerous advantages, for example, the solar lamps are energy saving. No power input is required because the solar lamps make use of the inexhaustible solar energy. Furthermore, the solar lamps typically have a sensor to detect the brightness of the surrounding environment whereby under a dim condition such as at night, the solar lamp is automatically activated, and contrarily when under a bright condition such as during a sunny day, the solar lamp is automatically shut off and the battery is charged. Therefore, manual control of the solar lamp is not necessary which makes the solar lamp especially suitable for use as a garden lamp.

Fountains are ornaments used in gardens. By utilizing soothing water movement, the fountain provides decorative effects to show a taste of elegance and therefore fountains have been historically popular. In recent years, the popularity of fountains has increased in accompaniment with the improving of people's living standards.

However, although the solar lamp and the fountain are both widely used in the illumination and the decoration of the garden, and respectively have the aforementioned advantages, no one has combined the solar lamp and the fountain into a new device that is able to provide a whole new ornamental effect as well as illumination to be used in open spaces.

Therefore, the present invention tends to provide a fountain in combination with a solar lamp to combine the advantages of a solar lamp and a fountain.

### SUMMARY OF THE INVENTION

An objective of the present invention is to provide a solar lamp in combination with a fountain that is able to create soothing waterfalls for ornamental purpose.

Another objective of the present invention is to provide a solar lamp in combination with a fountain that is able to provide illumination under dim conditions.

Other objectives, advantages and novel features of the invention will become more apparent from the following detailed description when taken in conjunction with the accompanying drawings.

### BRIEF DESCRIPTION OF THE DRAWINGS

FIG. 1 is an exploded, perspective view of a solar lamp in combination with a fountain in accordance with the present invention;

FIG. 2 is a cross-sectional view of the solar lamp in combination with the fountain in assembly; and

FIG. 3 is a perspective view of another preferred embodiment in accordance with the present invention.

### DETAILED DESCRIPTION OF THE PREFERRED EMBODIMENT

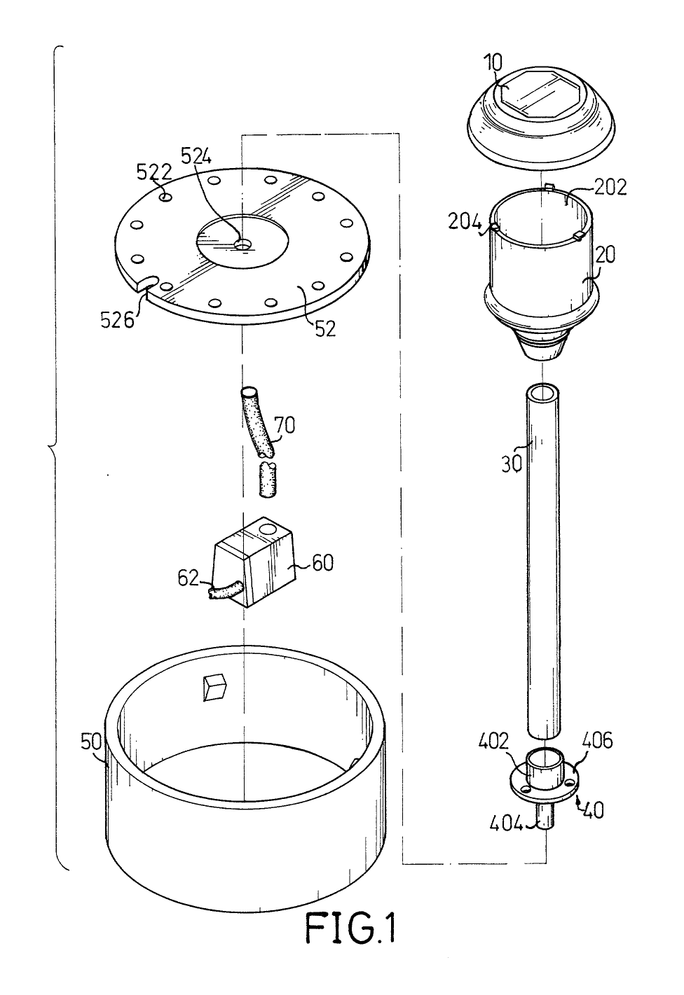

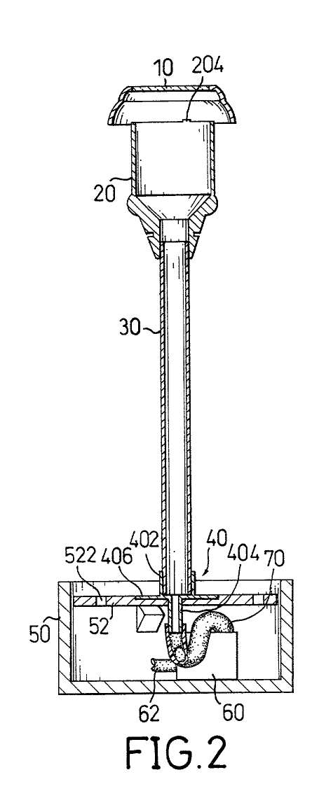

With reference to FIGS. 1 and 2, a solar lamp in combination with a fountain in accordance with the present invention includes a solar lamp (10), a cylinder (20), a tube (30), a connector (40), a base (50), and a pump (60).

The solar lamp (10) is a currently available device provided with a sensor to detect the brightness of the surrounding environment. When in a bright condition, for example, during daylight hours of a sunny day, the solar lamp (10) is shut off and transforms solar energy to charge a battery. When in a dimly-lit condition, such as at night, the potential energy stored in the battery lights up the solar lamp (10). The activation and shutting off of the solar lamp (10) is automatically controlled by the sensor.

The cylinder (20) is hollow and has an outlet (202) defined in a top face of the cylinder (20). Multiple protrusions (204) are evenly distributed on the top face of the cylinder (20) and surround the outlet (202). The solar lamp (10) is securely connected on top of the protrusions (204).

The tube (30) has a top open end securely connected to a bottom face of the cylinder (20) in a manner that an interior of the tube (30) communicates with an interior of the cylinder (20).

The connector (40) is hollow and has an upper pipe (402), lower pipe (404), and a retaining ring (406), wherein the upper pipe (402) communicates with the lower pipe (404) and the retaining ring (406) is formed around and extends out from a middle section of the connector (40).

The base (50) is hollow and has a top opening. A disk (52) is disposed to cover the top opening. Multiple communicating bores (522) and a central bore (524) configured slightly larger than the lower pipe (404) are defined through the disk (52). The pump (60) is provided inside the base (50) and has a wire (62) extending out of the base (50) through a notch (526) defined in the disk (52) to connect to an electric power supply.

Referring to FIG. 2, when assembling the solar lamp in combination with the fountain, the connector (40) is positioned on top of the disk (52) and the lower pipe (404) extends into the central bore (524). A hose (70) is disposed inside the base (50) and connects the pump (60) and the lower pipe (404). Finally, the solar lamp (10), the cylinder (20), and the tube (30) that are sequentially connected together are assembled onto the base (50) by force fitting between a bottom end of the tube (30) with the upper pipe (402) of the connector (40).

When in operation, the solar lamp in combination with the fountain is placed outdoors in open spaces such as gardens. A suitable amount of water is added in the base (50) and the wire (62) is connected to the electric power supply. Then the pump (60) is activated so that the water in the base (50) is pumped into the cylinder (20) via a passage in the hose (70), the connector (40), and the tube (30). When the cylinder (20) receives its full storage capacity of water, the water begins to spill over through the space between the protrusions (204) and thereby forms soothing waterfalls. The water spilled over is further dropped down on the disk (52) and flows into the base (50) via the communicating bores (522) so that the base (50) collects the water for the pump (60) to recycle. Moreover, the illumination of the solar lamp (10) is automatically controlled by the sensor such that when under a bright condition, the solar lamp (10) is shut off and the battery is charged by the solar energy. Contrarily, when under a dimly-lit condition, the solar lamp (10) is activated and illuminates using the energy stored in the battery.

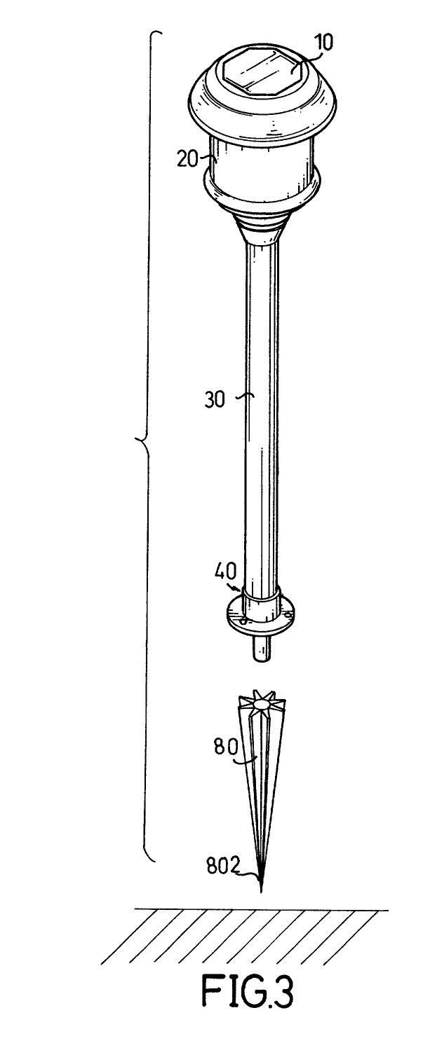

With reference to FIG. 3, another preferred embodiment in accordance with the present invention is shown. The base (50) of the previous preferred embodiment is replaced with a foot (80) securely connected with the connector (40). The foot (80) is configured substantially conic and has a sharp tip (802). Therefore, in this preferred embodiment, the interrelation among the solar lamp (10), the cylinder (20), the tube (30), and the connector (40) remains unchanged and the solar lamp in accordance with the fountain is now rearranged into a solar lamp device. The lamp device is stood by pushing the tip (802) into the ground and therefore is suitable to be used in gardens and other places where the ground is soft for the tip (802) to easily protrude into.

From the above description, it is noted that the invention has the following advantages:

1. ornamental effect:

The solar lamp in combination of the fountain is able to create soothing waterfalls which provides an ornamental effect and shows an elegant taste when placed in gardens.

2. illumination effect:

The solar lamp (10) is able to provide illumination so as to enable the waterfalls to be seen at night and to enhance the ornamental effect mentioned in previous advantage.

3. automatically controlled:

The solar (10) is automatically activated and shut off by a sensor detecting the brightness of the surrounding environment thus manual control is not necessary.

While this invention has been particularly shown and described with references to the preferred embodiment thereof, it will be understood by those skilled in the art that various changes in form and details may be made therein without departing from the scope of the invention encompassed by the appended claims.

What is claimed is:

1. A solar lamp in combination with a fountain comprising:
a hollow base for receiving therein water and having a top opening, a disk covering the top opening, the disk having multiple communicating bores and a central bore defined through the disk;
a pump disposed inside the base;
a connector mounted on the disk, the connector being hollow and having a lower pipe extending into the central bore;
a hose connected between the lower pipe and the pump to communicate the pump with the connector;
a cylinder corresponding to and communicating with connector; the cylinder being hollow and having an outlet defined on a top face of the cylinder; and
a solar lamp securely mounted on the cylinder,
whereby the water is pumped by the pump from the base to the cylinder via the hose and the connector and further spills over from the outlet, the water is then collected by the base via the top opening and recycled by the pump.

2. The solar lamp in combination with the fountain as claimed in claim 1 further comprising a tube connecting and communicating the connector and the cylinder.

3. The solar lamp in combination with the fountain as claimed in claim 2, wherein multiple protrusions are formed on the top face of the cylinder and securely connect the solar lamp to the top face of the cylinder to allow the water to spill over through spaces between the multiple protrusions.

4. The solar lamp in combination with the fountain as claimed in claim 2, wherein the connector further has an upper pipe configured to be force fitted with tube.
